(19) United States
(12) Patent Application Publication
(10) Pub. No.: US 2013/0293056 A1
(43) Pub. Date: Nov. 7, 2013

(54) STATOR COIL OF ELECTRIC MACHINE

(71) Applicant: MING-TE CHENG, KAOHSIUNG CITY (TW)

(72) Inventor: MING-TE CHENG, KAOHSIUNG CITY (TW)

(73) Assignee: PREJECTION INDUSTRIAL CORP., KAOHSIUNG CITY (TW)

(21) Appl. No.: 13/464,121

(22) Filed: May 4, 2012

(51) Int. Cl. H02K 3/28; H02K 1/12

(52) U.S. Cl. 310/216.001

(57) ABSTRACT

Stator coils of electric machines are revealed. A stator plate is fixed on an axle of an electric machine and an external rotor of an electric machine spins with respect to a stator. A plurality of cores made from silicon steel plates is disposed in a circle around the stator plate. Each core is wound with at least two layers of flat coils and the two adjacent coils are wound in opposite directions. Thereby the stator coils have a stronger magnetic field. Thus the electric machine with the stator coils is of high torque.

### BACKGROUND OF THE INVENTION

1. Field of the Invention

The present invention relates to stator coils of electric machines, especially to stator coils applied to electric machines required for high torque. The coils create magnetic flux lines with high density so as to produce high torque.

2. Description of Related Art

Electric machines are electro-mechanical energy converters. The conversion is bi-directional and is based on electromagnetic induction. The electric machine that converts mechanical power to electricity is called “electric generator” while the other kind of electric machine that converts electricity to mechanical power is known as “electric motor”. The most well-known electric machines include generators, motors, etc. Motors are broadly applied to various produces as mina power sources, especially to devices with higher speed or torque such as compressors, conditioners, juice machines, electric vehicles (electric cars, scooters), etc. The motor works by sending an electric current through a stator surrounded with coils to make an electromagnetic field. Large motors use two electromagnetic fields that push each other to make an armature with magnetism spin. Thus electric power is converted to mechanical power.

Electric cars are vehicles with features of environmental protection and energy efficiency. The power source of the electric car is an electric power system whose key components are motors. Since the motor is the main power source, the operating performance, accelerating performance, climbing performance, maximum speed and driving range are all affected by performance of the motor. Through a proper gear ratio of a transmission system, the motor gets torque and power required for running. The most common motors used in electric cars include a brush DC (direct current) motor, a brushless DC motor, AC (alternating current) induction motor, all have their respective advantages and drawbacks. In recent days, a hub motor is quite popular. There are various mechanical designs of the motor. Generally, the motor includes a stator with a plurality of winding holes around a periphery thereof. The winding holes are separated from one another by a winding wall and coils whose cross section is a round are wound around the winding wall. Thus the stator of the motor is formed. Moreover, coils are arranged outside the stator. The coils are disposed with a magnetic body on an inner wall thereof to form an armature. While in use, the coils are applied with an electric current to generate a magnetic field. Then the magnetic body on the inner wall of the coils starts to spin and drive followers assembled with the coils to move under the influence of the magnetic field.

However, for winding coils, the coils are inserted through the narrow winding hole, around the winding wall and then inserted into the adjacent winding hole. Repeat the processes to form coils wound around the winding wall. In practice, it's time consuming to wind the coils through the narrow winding hole. The production efficiency is reduced. Moreover, such disposition way of the coils with the round cross section occupies more space and the weight of the coils is quite heavy. Furthermore, the magnetic flux generated is with lower density. Under low speed, the motor is unable to generate high torque. Thus the driving effect is poor.

### SUMMARY OF THE INVENTION

Therefore it is a primary object of the present invention is to provide stator coils of electric machines that improve insufficient torque problems of electric machines by producing high magnetic flux density and magnetic field lines with high density to make electric machines have larger start torque.

In order to achieve the above object, a stator plate is fixed on an axle of an electric machine and an external rotor revolves corresponding to a stator. A plurality of cores made from silicon steel plates is disposed on the stator plate, in a ring form around the stator plate. Each core is wound with at least two layers of flat coils and two of the flat coils adjacent to each other are wound in opposite directions. Thereby the stator coils have stronger magnetic filed with denser magnetic flux. The electric machine with the stator coils is further of high torque.

The two layers of flat coils form a coil set and the two flat coils are wound in opposite directions. The core is wound with at least one coil set. The flat coils of two adjacent coil set are also wound in opposite directions. Thus the stator coils have a denser magnetic field (higher magnetic flux) and the electric machine with the stator coils generates high torque.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front view of an embodiment according to the present invention;

FIG. 2 is a perspective view of flat coils of an embodiment according to the present invention;

FIG. 3 is a schematic drawing showing a side view of an embodiment according to the present invention;

FIG. 4 is a schematic drawing showing magnetic lines of an embodiment according to the present invention;

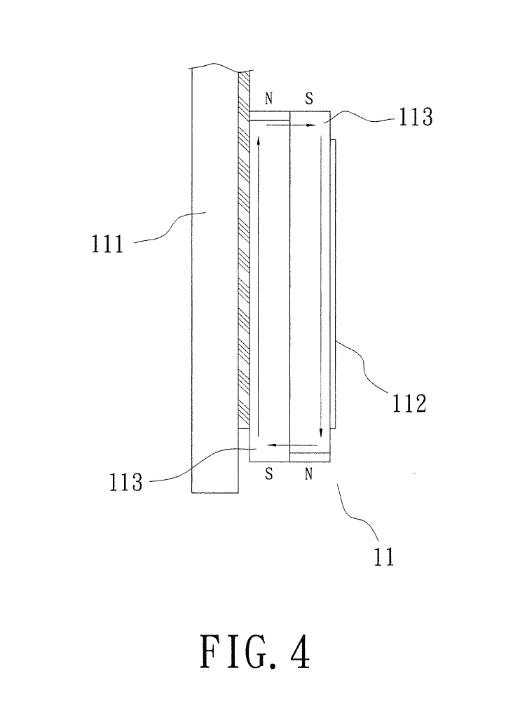

FIG. 5 is a schematic drawing showing another state of an embodiment according to the present invention.

### DETAILED DESCRIPTION OF THE PREFERRED EMBODIMENT

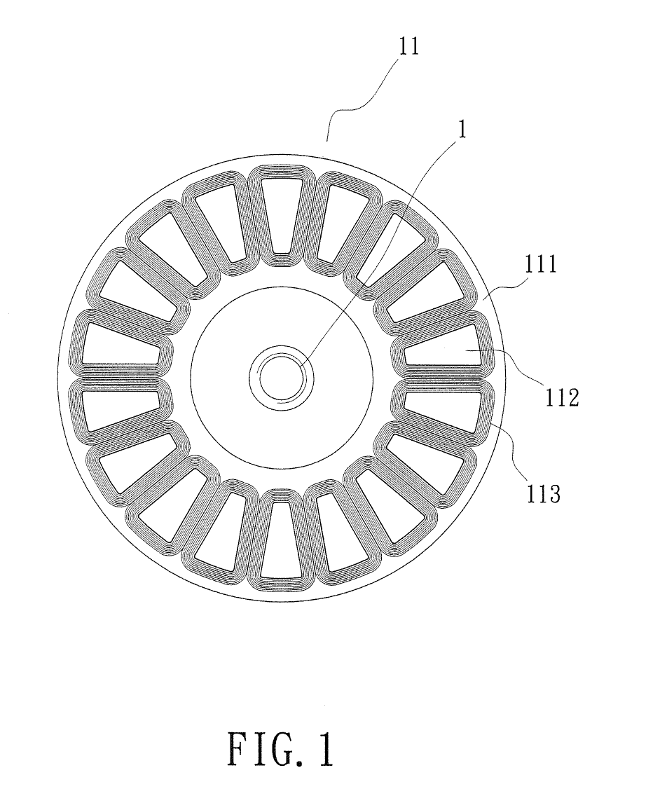

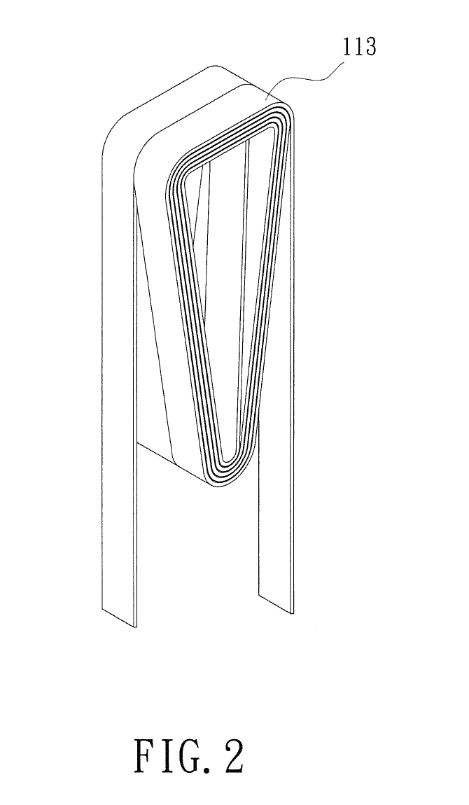

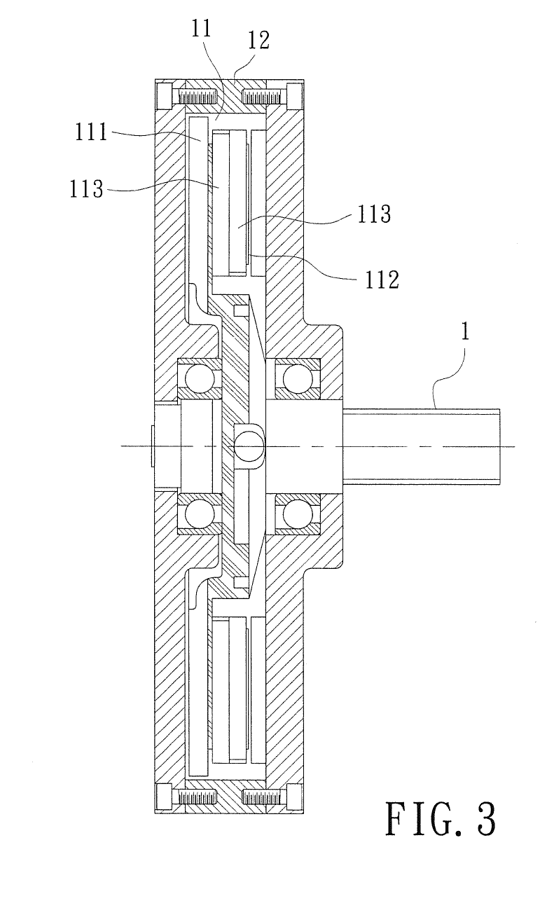

Refer to FIG. 1, FIG. 2 and FIG. 3, an embodiment of stator coils of electric machine according to the present invention are applied to electric machines with large start torque mainly and having a stator 11 fixed on an axle 1 of the electric machine and an external rotor 12 of the electric machine rotating corresponding to the stator 11.

The stator 11 consists of a stator plate 111, a plurality of cores 112 and flat coils 113. The cores 112 are made from silicon steel plates and arranged around a periphery of a surface of the stator plate 111. Each core 112 is wound with flat coils 13. At least two layers of flat coils 113 are wound around the core 112 and two adjacent flat coils 113 are wound in opposite directions.

Thereby once the state 11 coils have a strong magnetic field (the denser the magnetic flux lines, the stronger the magnetic filed), and the electric machine with the state coils have high torque.

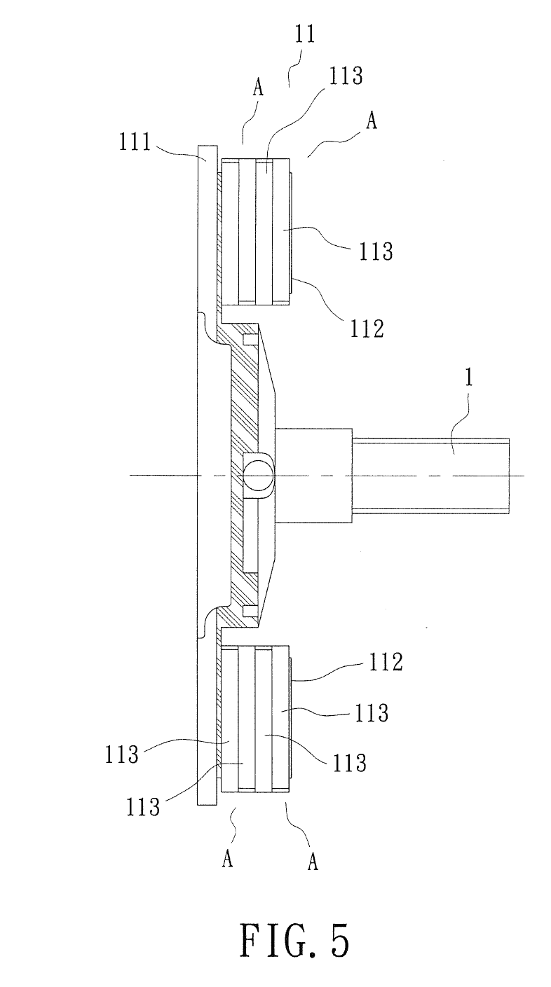

While being assembled, the stator 11 that doesn't rotate is fixed on the axle 1 of electric machines while the external rotor 12 of electric machines revolves with respect to the stator 11. The stator 11 is disposed with the stator plate 111 and the plurality of cores 112 made from silicon steel plates is arranged around the periphery of the stator plate 111. Each core 112 is wounded with coils. The structure of the coils wound around each core 112 includes at least two layers of flat coils 113. And the two adjacent flat coils 113 are wound in opposite directions. In another embodiment, as shown in FIG. 5, the winding of the stator coil includes two layers of flat coils 113 that form a coil set A. In this coil set A, the two layers of flat coils 113 are wounded in opposite directions. At least one coil set A is wound around the core 112. In this embodiment, there are two coil sets A and the flat coils 113 of the two adjacent coil sets A are also wound opposite to one another.

When a current is applied, the stator 11 coil generates a magnetic field with respect to the rotor 12. Due to opposite directions of the flat coils 113 being wound, a circular arrangement in which N poles and S poles are alternately arranged is formed. Beside magnetic flux lines produced by each layer of coils, a denser magnetic field (higher magnetic flux) is created due to a stack with alternating N poles and S poles. The higher the density of the magnetic flux lines, the stronger the magnetic field.

How the electric machine with the present invention has a stronger magnetic field and higher torque is explained in details in the following. Electrical motor efficiency is the ratio between the output power and the input power. Loss in motor efficiency is determined by the difference between the input power and the output power. The number kw marked on a motor nameplate represents the output power and this power is unable to be changed. In order to improve the motor efficiency, the only way is to reduce the loss. The loss is divided into five groups including primary copper loss, iron loss, secondary copper loss, mechanical loss and stray loss. The primary copper loss is the loss when the current passes the stator coil. Once a current I flows through an object with resistance R, electrical energy is converted to heat and there is a loss I²×R. I is the current that flows through the object (amperes) while R equals the resistance (ohms). In order to create rotating magnetic field, coils are wound around the stator core. When there are coils, there is resistance. The primary copper loss is reduced by the following method-increasing the wire diameter of the coils. Resistance R=ρ(λ/A). The resistance is inversely proportional to the cross-sectional area A of the coils. The larger the cross-sectional area A is, the smaller the resistance R is. Then I²×R is reduced.

Inductance=(coil turns×magnetic flux)/current.

With the same silicon steel plates and the direct current (DC) with the same magnitude, the inductance of round coils is 42 uH and DC resistance (DCR) is 46.6 mΩ while the inductance of flat coils is 41 uH and DC resistance (DCR) is 27.3 mΩ. Due to smaller cross sectional area of the round enameled copper wire, the number of turns of coils being wound is larger to have higher inductance value. According to the following equation—magnetic flux density (B)=magnetic flux (Φ)/cross-sectional area of vertical magnetic lines (A)=permeability (μ)×magnetic field strength (H), it is learned that the magnetic flux is proportional to the magnetic flux density, and the magnetic field strength. In the present invention, the cross sectional area A is increased by the winding of double layers of the flat coils. Under the condition of the same current, the inductance measured is 2.24 uH and the DC resistance 7.5 mΩ. With the flat coils and the silicon steel plates, the inductance detected is 9.0 uH and the DC resistance is 7.5 mΩ. No matter how many turns the coils wound, the resistance is the same and the resistance is reduced compared with the enameled copper wire. The double layers of the flat coils wound in this embodiment make the inductance value become lower while the magnetic flux induced by the current become higher. Thus the electric machine is with higher torque when it starts running.

In summary, the stator coils of electric machines of the present invention have following advantages
1. The stator coils of electric machines of the present invention improve torque of the electric machine. By the design of layers of the flat coils arranged in opposite directions, the stator coils have a stronger magnetic field with denser magnetic flux lines.
2. By the design of layers of the flat coils arranged in opposite directions, the electric machine generates high torque.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. Stator coils of electric machines comprising:
a stator of an electric machine; the stator having a stator plate and used for making an external rotor of the electric machine revolve; and
a plurality of cores arranged circularly around the stator plate and each core wound with stator coils;
wherein each core is wound with at least two layers of flat coils and two of the flat coils adjacent to each other are wound in opposite to directions.

2. The stator coils of electric machines as claimed in claim 1, wherein the core is made from silicon steel plate.
